(19) United States
(12) Patent Application Publication
(10) Pub. No.: US 2015/0070432 A1
(43) Pub. Date: Mar. 12, 2015

(54) IMAGE FORMING APPARATUS CAPABLE OF CONVEYING A SHEET ABSORBED WITH AN ELECTRIC CHARGE

(71) Applicant: Shinji Imoto, Setagaya-ku (JP)

(72) Inventor: Shinji Imoto, Setagaya-ku (JP)

(21) Appl. No.: 14/483,183

(22) Filed: Sep. 11, 2014

(30) Foreign Application Priority Data
Sep. 12, 2013 (JP) 2013-189876
Jun. 24, 2014 (JP) 2014-128785

(51) Int. Cl. B41J 13/00

(52) U.S. Cl. CPC B41J 13/0009
USPC 347/16

(57) ABSTRACT

An image forming apparatus includes a printing device; a conveyor, a first electric charger to charge the conveyor, a second electric charger to charge the printing medium, a surface potential detector to detect a surface potential of the printing medium, and a controller that adjusts a voltage applied to the second electric charger. The controller determines a target value for the surface potential at a location corresponding to a position of the surface potential detector based on a detection value of the surface potential detector in response to a first voltage being applied to the first electric charger and a second voltage being applied to the second electric charger. The controller adjusts the voltage applied to the second electric charger and the surface potential at the location corresponding to the position of the surface potential detector reaches the target value.

### CROSS-REFERENCE TO RELATED APPLICATIONS

This patent application is based on and claims priority pursuant to 35 U.S.C. §119 to Japanese Patent Application Nos. 2013-189876, filed on Sep. 12, 2013, and 2014-128785, filed on Jun. 24, 2014, in the Japan Patent Office, the entire contents of each of which is hereby incorporated by reference herein.

### BACKGROUND

1. Technical Field

Embodiments discussed herein relate to a conveying device for an image forming apparatus, and in particular, to a conveying device and an image forming apparatus capable of conveying a sheet secured with an electric charge.

2. Related Art

As an image forming apparatus, such as a printer, a facsimile machine, a copier, a plotter, a multifunctional machine combining these capabilities, etc., an ink-jet printer that employs a droplet ejecting-type printing system with a droplet discharging head that ejects the droplet is known. In such an image forming apparatus, a droplet having landed on a printing medium takes a long time to dry and form an image thereon. For this reason, the printing medium is conveyed with its image forming surface distanced from (i.e., not contacting) a sheet conveying device until the droplet on the printing medium dries.

Certain known conveying systems convey the printing medium using electrostatic force generated in a sheet conveying device to attract the printing medium. However, it is difficult to adjust a surface potential of the printing medium to be set to 0V, under a printing head acting as an image forming device. In order to control the surface potential of the printing medium under the printing head, it is effective to arrange a surface potential sensor near the printing head. However, a performance of the surface potential sensor can be affected by humidity, and detection accuracy can decrease under the influence of the ink ejected because of a position of the surface potential sensor being near the printing head.

Thereby, although a surface potential sensor is generally arranged so that it is separated from a position of the printing head, the surface potential of the printing medium at a location corresponding to in a position of the surface potential sensor is different from that of the printing medium in a location under the printing head. This is especially the case in low-temperature or low-humidity environments, in which the electrical resistance of the printing medium generally increases, making it difficult to negate the electric field under the printing head caused by the surface potential of the printing medium. As a result, a reverse flow of ink mist toward the printing head arises due to the electric field.

### SUMMARY

Accordingly, one aspect of the present disclosure provides an image forming apparatus that includes an image forming head that ejects droplets and forms an image on a printing medium; a conveyor that conveys the printing medium with the image in a conveying direction; at least one first electric charger that charges the conveyor; a second electric charger that charges the printing medium; a surface potential detector downstream of the second electric charger in the conveying direction detects a surface potential of the printing medium; and a controller that adjusts a voltage applied to the second electric charger. The controller determines a target value for the surface potential of the printing medium at a location corresponding to a position of the surface potential detector based on a detection value detected by the surface potential detector in response to a first voltage being applied to the first electric charger and a second voltage being applied to the second electric charger. The controller adjusts the voltage applied to the second electric charger and the surface potential of the printing medium at the location corresponding to the position of the surface potential detector reaches the target value.

### BRIEF DESCRIPTION OF THE DRAWINGS

A more complete appreciation of the present invention and the advantages thereof will be understood by reference to the following detailed description when considered in connection with the accompanying drawings. In the drawings:

FIG. 1 is a diagram illustrating the overall configuration of an exemplary image forming apparatus according to an embodiment of the present disclosure;

FIG. 2 is a schematic plan view illustrating a mechanism according to an embodiment of the present disclosure;

FIG. 3 is a side view illustrating a conveyor according to an embodiment of the present disclosure;

FIG. 4 is a diagram illustrating a mechanism to engage and disengage a driven roller with a driving roller when a sheet is linearly ejected therefrom according to an embodiment of the present disclosure;

FIG. 5 is a diagram illustrating an attraction principle of a conveying roller that adsorbs a sheet as a rotary conveying device according to an embodiment of the present disclosure;

FIG. 6 is a block diagram of a controller according to an embodiment of the present disclosure;

FIG. 7 is a diagram illustrating exemplary charged states of a sheet and a sheet conveying belt when an electric charging control is executed, according to an embodiment of the present disclosure;

FIG. 8 is a chart illustrating exemplary results of measuring a surface potential of a sheet according to an embodiment of the present disclosure;

FIG. 9 is a chart illustrating a relationship between an electrical resistance of a sheet and a target value of a surface potential of the sheet at a location along an image forming conveyance path corresponding to a position of a surface potential sensor according to an embodiment of the present disclosure;

FIG. 10 is a chart illustrating a relationship between an electrical resistance of a sheet and a target value of a surface potential of the sheet at a location along an image forming conveyance path corresponding to a position of a surface potential sensor for a duplex printing operation according to an embodiment of the present disclosure;

FIG. 11 is a chart illustrating a relationship between a thickness of a sheet and a target value of a surface potential of the sheet at a location along an image forming conveyance path corresponding to a position of a surface potential sensor according to an embodiment of the present disclosure; and

FIGS. 12A and 12B are flowcharts illustrating a surface potential control by a controller according to an embodiment of the present disclosure.

### DETAILED DESCRIPTION

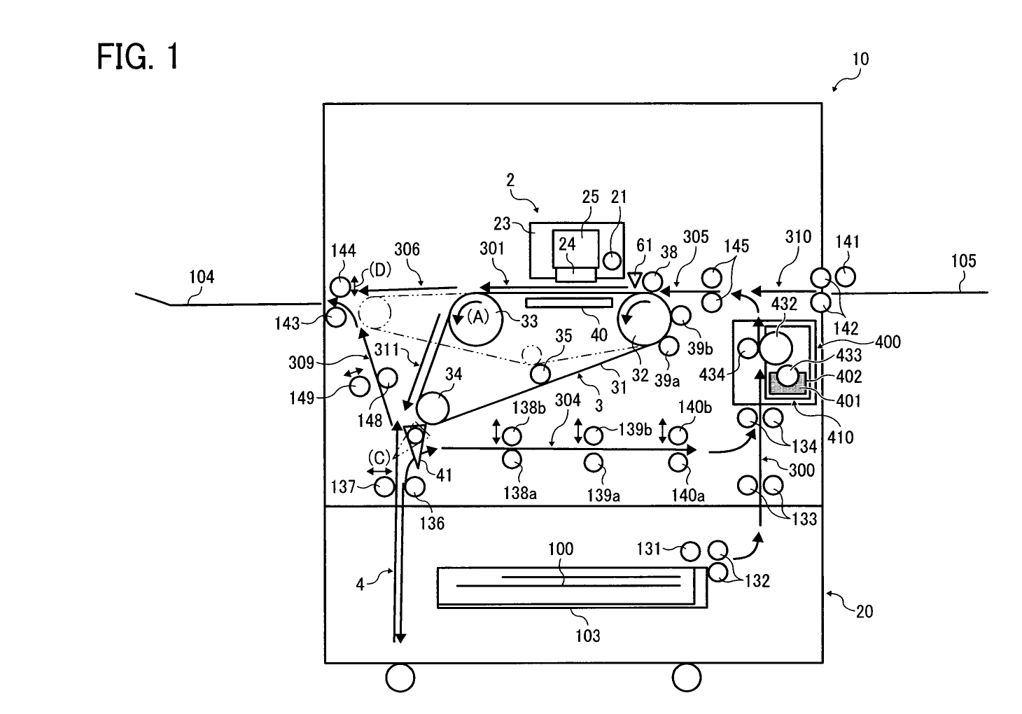

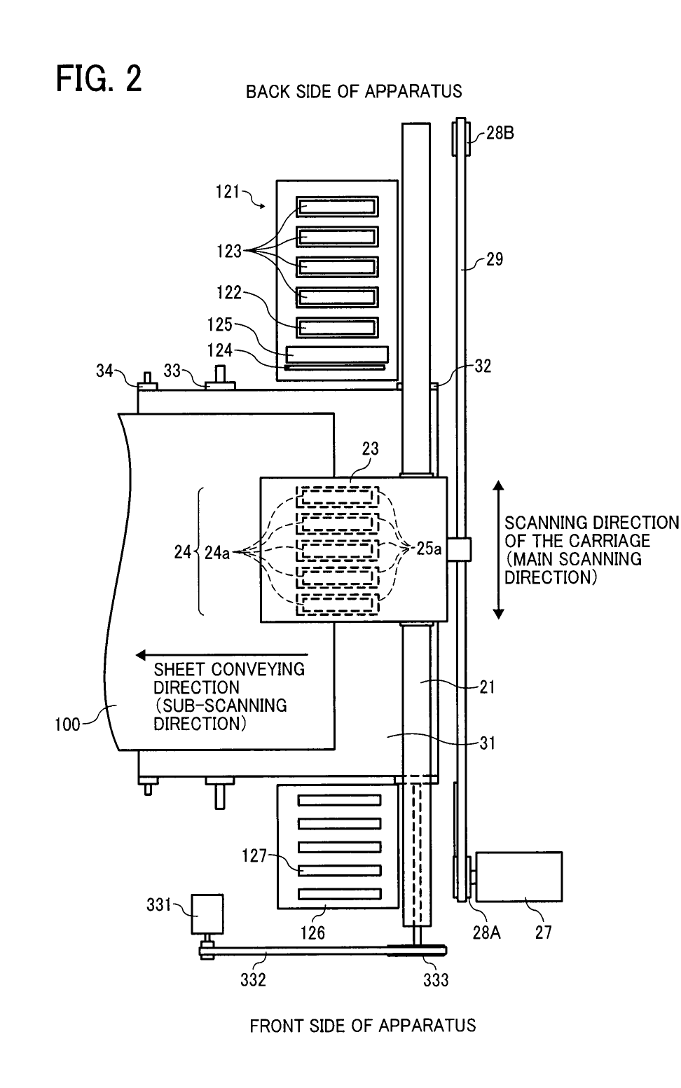

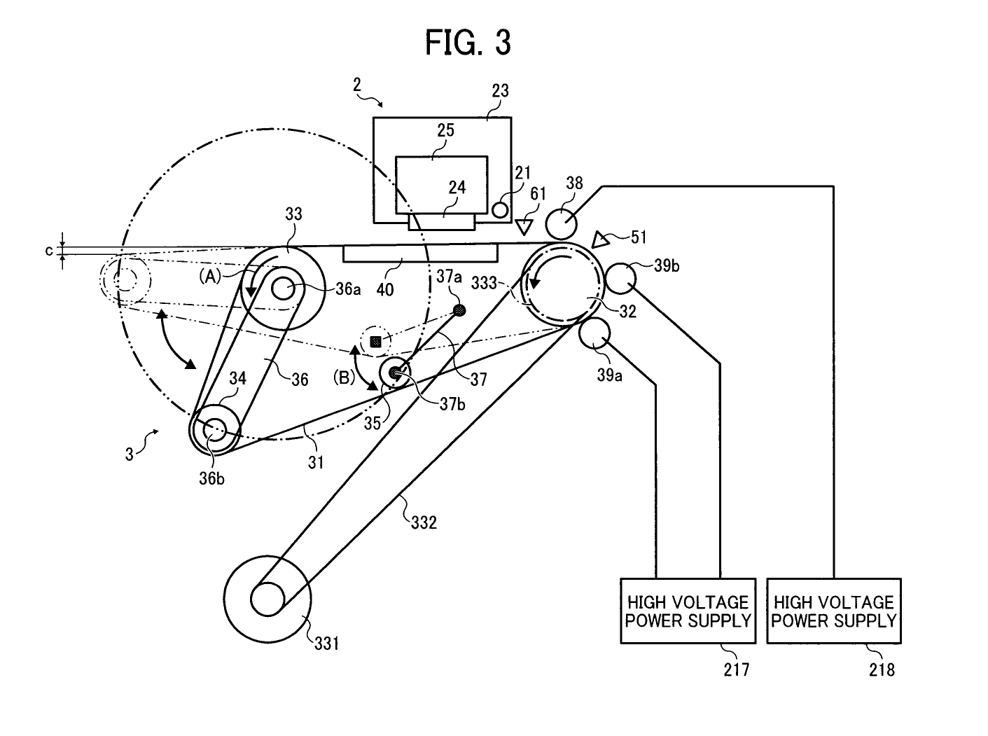

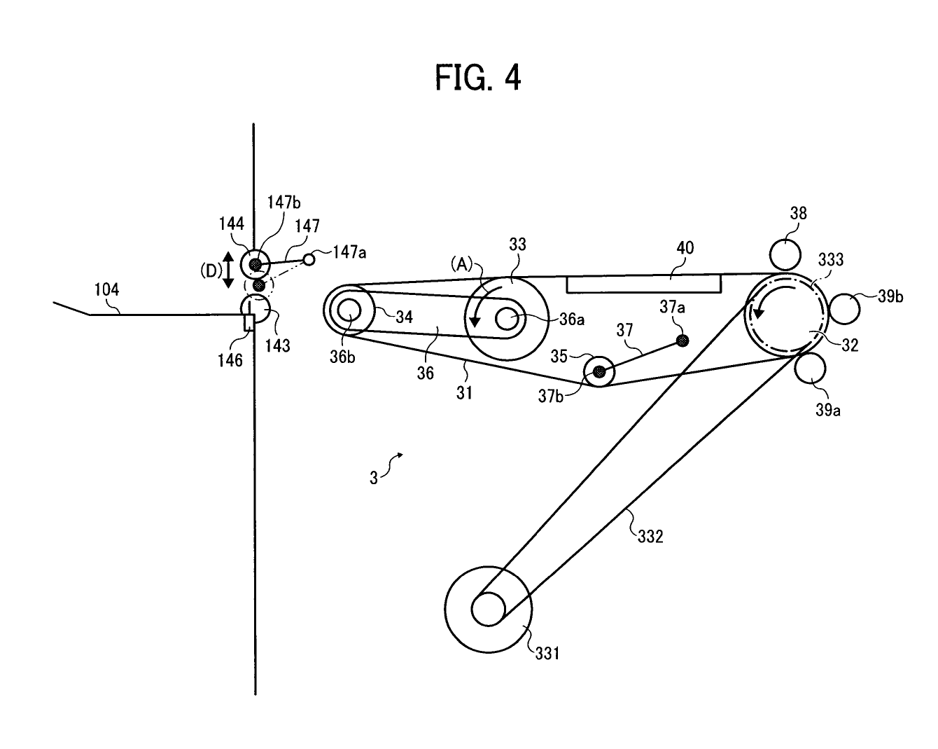

Referring now to the drawings, wherein as reference numerals designate identical or corresponding parts throughout the several views thereof and in particular to FIGS. 1 to 4, an exemplary image forming apparatus which has a sheet conveying device according to an embodiment of the present disclosure is described. Specifically, an overall configuration of an exemplary image forming apparatus is illustrated in FIG. 1. A mechanism is included in the image forming apparatus as shown in FIG. 2. A conveying device is disposed in the image forming apparatus as shown in FIG. 3. The mechanism causes a driven roller to engage and disengage with a driving roller when a sheet is linearly ejected from the image forming apparatus as shown in FIG. 4.

The image forming apparatus includes an image forming head 2 that forms an image by ejecting a droplet onto a printing medium in the form of a sheet 100. The image forming apparatus includes a conveyor 3 that conveys the sheet 100 inside an apparatus body 10, a processing liquid coating unit 400 on an upstream side of the image forming head 2 in a sheet conveying direction to coat the sheet 100 with processing liquid 401, and a sheet-inverting unit 4 to invert the sheet 100 bearing the image thereon. Further, the image forming apparatus includes a sheet-exiting tray 104 to receive the sheet 100 drained therefrom, and a sheet feeding cassette 103 disposed in a lower section of the apparatus body 10 to accommodate multiple sheets 100.

As illustrated in the FIGS. 1 and 2, the image forming head 2 supports a carriage 23 by a guiding rod 21 and a guiding tray (not shown). The carriage 23 includes multiple printing heads of respective colors aligned in a main scanning direction, and is supported to move in the main scanning direction. The carriage 23 moves and executes scanning in the main scanning direction when driven by a main scanning motor 27 via a timing belt 29 that is wound around a driving 28A and a driven pulley 28B.

On the carriage 23, a printing head 24 including a plurality of droplet discharging printing heads 24a that eject droplets of respective colors of black (Bk), cyan (C), magenta (M), and yellow (Y), is mounted. Two the printing heads are used to eject Bk droplets. In this configuration, an image is formed by ejecting an applicable droplet from the printing head 24 onto a sheet 100 while moving the carriage 23 in the main scanning direction, and conveying the sheet 100 from the conveyor 3 in a sheet conveying direction (i.e., a sub-scanning direction), in a manner such as a shuttle type system.

Alternatively, a line type printing head including multiple printing heads of respective colors aligned in the sub-scanning direction can be utilized as well. However, the present disclosure is not limited to the above-described alignments of printing heads and nozzle lines of the printing heads, and an alignment order of respective colors.

Multiple printing head tanks 25a providing a printing head tank unit 25 are mounted on the carriage 23 to supply liquids of multiple colors to the respective discharging printing heads 24a of the printing head 24. Multiple color liquids are respectively supplied to the multiple printing head tank unit 25 from liquid cartridges removably mounted on the apparatus body 10 from a front side thereof. Here, the image forming apparatus is enabled to supply black ink from a single liquid cartridge to a pair of the multiple printing head tanks 25a.

The printing head 24 can employ a pressure generating device, such as a piezoelectric-type actuator, a thermal type actuator, or an electrostatic type actuator, for example. However, the present disclosure is not limited to the above-described exemplary droplet discharging unit.

Further, as illustrated in FIG. 2, a maintenance and recovery mechanism 121 is positioned in a non-printing region located at one side of the image forming apparatus in a widthwise direction that corresponds to the scanning direction of the carriage 23. The recovery mechanism 121 recovers and maintains a condition of nozzles of the printing head 24.

The maintenance and recovery mechanism 121 includes moisture retaining caps 123 and a suction cap 122 connected to a suction device (not shown) to cap surfaces of the discharging printing heads 24a. The maintenance and recovery mechanism 121 includes a wiper 124 to wipe multiple nozzle surfaces of the discharging printing heads 24a. The maintenance and recovery mechanism 121 includes a trial discharged ink receiver 125 to receive a droplet not contributing to printing (i.e., image formation) discharged thereon (as trial ink discharging).

Further, as illustrated in FIG. 2, a trial discharged ink receiver 126 is positioned in a non-printing region at an opposite side of the image forming apparatus in the widthwise direction of the image forming apparatus that corresponds to the scanning direction of the carriage 23. The discharged ink receiver 126 receives droplets discharged from the discharging printing heads 24a thereon not contributing to printing (i.e., image formation) as trial ink. In the trial discharged ink receiver 126, openings 127 are formed corresponding to the discharging printing heads 24a.

As further illustrated in FIG. 3, a sheet conveying belt 31 provides an endless sheet conveyor, and is provided in the conveyor 3 to adsorb and send the sheet 100 fed from the bottom while directing the sheet to face the image forming head 2.

The sheet conveying belt 31 is wound around a conveying roller 32 that provides a driving roller, another conveying roller 33 that keeps an image formation region flat in cooperation with the conveying roller 32, a separating roller 34 arranged downstream of the conveying roller 33 in the sheet conveying direction, and a tension roller 35. A guide member 40 is also positioned facing the image forming head 2 to guide the sheet conveying belt 31 in a region opposite to the image forming head 2.

The sheet conveying belt 31 is preferably a two-tiered structure. For example, the sheet conveying belt 31 includes a front surface acting as a sheet attraction surface made of pure resin such as ETFE (Ethylene tetrafluoroethylene) pure materials, for example, not subjected to resistance control. A back side layer (e.g. a medium resistance layer, a grounded layer) of the sheet conveying belt 31 may be made of the same material as the front surface, and is subjected to resistance control with carbon. However, the present disclosure is not limited to the above-described configuration, and alternatively, the sheet conveying belt 31 can be constituted as a single layer or as a multilayer structure having three or more layers.

The separating roller 34 is provided to separate the sheet 100 with the image adhering to the sheet conveying belt 31 using a curvature separation principle. illustrated in FIG. 3, the separating roller 34 is rotatably held by a shaft 36b provided at an end of a movably rotatable link 36. The movably rotatable link 36 is movable around a rotating center of the conveying roller 33 acting as a supporting point 36a in a direction as indicated by an arrow (A). The separating roller 34 is also enabled to swing between two corresponding positions in multiple conveying paths as shown by solid and broken lines, respectively. Specifically, the separating roller 34 is positioned to be able to convey the sheet 100 in each sheet conveying path.

In moving the separating roller 34 to a position as indicated by a broken line in FIG. 3, the separating roller 34 switches a respective position to enter a straight sheet ejecting path 306, in which the sheet 100 bearing the image thereon is linearly conveyed and sent toward the sheet-exiting tray 104. In contrast, in moving the separating roller 34 to a position indicated by a solid line in FIG. 3, the separating roller 34 switches a respective position to enter a sheet inverting path 311, in which the sheet 100 bearing the image is sent to a sheet-inverting unit 4.

A sheet conveyance distance between a location of the image forming head 2 and a position in which the sheet 100 is separated from the sheet conveying belt 31 is substantially the same in the straight sheet ejecting path 306 and the sheet inverting path 311. As a result, with such an arrangement, a drying degree of the sheet 100 can be the same regardless of a type of the sheet conveying path, in which the sheet 100 is conveyed (i.e., the straight sheet ejecting path 306 or the sheet inverting path 311), so that the same quality of the image can be obtained regardless of a sheet conveying path being used.

Since the separating roller 34 is rotatable around the rotational center of the conveying roller 33 functioning as a fulcrum as described above, a sheet conveying distance between a location where the separating roller 34 separates the sheet 100 from the sheet conveying belt 31 and a position of the image forming head 2 can be substantially the same in the straight sheet ejecting path 306 and the sheet inverting path 311.

The separating roller 34 is positioned at a predetermined position (e.g., at a given minimum distance from the conveying roller 33) to enable the sheet conveying belt 31 to always contact the conveying roller 33 with a prescribed tension. Even when the sheet conveying path is switched, a posture of the sheet conveying belt 31 does not change at an image forming region, so that an image can be steadily formed.

In a situation where the separating roller 34 is located at the position indicated by the broken line in FIG. 3, the separating roller 34 as a whole is positioned below a conveying surface formed by the pair of conveying rollers 32 and 33 that hold the sheet conveying belt 31 facing the image forming head 2. Specifically, the separating roller 34 is placed lower than the conveying surface by a distance (c) as shown in FIG. 3. Accordingly, the sheet conveying belt 31 can contact the conveying roller 33 while ensuring its flatness.

Further, as illustrated in FIG. 3, a tension roller 35 is held by an arm 37 that is swingable between positions as shown by solid and broken lines in a direction as indicated by arrow (B) in the drawing. Specifically, the arm 37 is swingable around a rotation fulcrum 37a acting as a fulcrum, and rotatably supports the tension roller 35 around a holding fulcrum 37b. The arm 37 is pressed by a pressing device (not shown) in a direction in which the tension roller 35 presses the sheet conveying belt 31 in a prescribed direction. The tension roller 35 moves following the sheet conveying belt 31 even when the sheet conveying belt 31 displaces due to swinging of the separating roller 34, and accordingly, provides a tension to the sheet conveying belt 31. By contrast, on an upstream side of the image forming head 2, a pressing member (e.g., a pressing roller) 38 is provided opposite the conveying roller 32 to press the sheet 100 against the sheet conveying belt 31 at an opposed position.

To attract the sheet 100 to the sheet conveying belt 31, a high power voltage (a power supply voltage), such as a DC (direct current) voltage, or a voltage provided by superimposing a DC voltage and an AC (alternating current) voltage, for example, is supplied from a high voltage power supply 218 (e.g., a DC bias supply unit or a DC and AC superposed bias supply unit and the like) to the pressing roller 38.

On the downstream side of the pressing roller 38, a surface potential sensor 61 is located in a position to detect a surface potential on the sheet 100 at the upstream side of the image forming head 2.

To charge a surface of the sheet conveying belt 31, a pair of electric charging rollers 39a and 39b collectively operate as first electric charge applying devices provided on the upstream side of the pressing roller 38 at different positions on the sheet conveying belt 31 in a belt circulating direction (i.e., a sheet conveying direction). To charge the sheet conveying belt 31, a high DC voltage or a high voltage provided by superimposing the DC and the AC voltage biases is supplied from the high voltage power supply 217 (, the DC bias supply unit or the DC and AC superimposed bias supply unit and the like) to the pair of electric charging rollers 39a and 39b.

On the downstream side of the electric charging roller 39b, a surface potential sensor 51 is positioned to detect a surface potential of the sheet conveying belt 31.

As illustrated in FIG. 3, as the conveying roller 32 is rotated by a sub-scanning motor 331 via a timing belt 332 and a timing roller 333, the sheet conveying belt 31 circulates in the sheet conveying direction (i.e., a sub-scanning direction) as shown in FIG. 2.

As illustrated in FIG. 1, the sheet-inverting unit 4 includes a conveying roller 136 composed of a conductive elastic member placed on the downstream side of the sheet conveying belt 31, and provides a rotary sheet conveyor. A driven roller 137 driven by the conveying roller 136 is provided to engage and disengage with the conveying roller 136 in the direction as indicated by arrow (C) to act as a driven rotated member. Further, the sheet-inverting unit 4 includes a path switching nail 41 that switches a sheet conveying path guiding the sheet 100 between a sheet inverting and ejecting path 309 and a double-sided sheet conveying path 304. Specifically, the sheet-inverting unit 4 inverts the sheet 100 and sends it to one of the sheet inverting and ejecting path 309 and a double-sided sheet conveying path 304.

At least a surface of the conveying roller 136 is composed of a conductive elastic member formed of a conductive elastic material such as conductive rubber, conductive sponge or similar material, for example. In exemplary embodiments in which the conductive elastic member is formed of a conductive rubber, solid rubber, such as EP rubber, chloroprene rubber, and polyurethane rubber, for example; and materials prepared by dispersing conductive carbon or conductive ions into foam rubber, can be used. A volume resistivity of the conductive elastic member is preferably from about 10² to about 10¹² (Ω-cm), and is more preferably from about 10³ to about 10⁶ (Ω-cm).

The driven roller 137 is placed to engage and disengage with the conveying roller 136 as described above, and presses the sheet 100 against the conveying roller 136 as it engages with the sheet 100.

Accordingly, when a prescribed sheet type (such as cardboard, for example), a condition of an environment, or other operating condition necessitates a prescribed feeding force larger than an attraction power of the sheet conveying roller 136 according to a previous analysis, is detected based on an output from a sheet thickness sensor, that of a temperature and humidity sensor (not shown) or an input from a user, for example, the driven roller 137 is pressed against the conveying roller 136. As a result, conveying power increases, and a problem, such as sheet jam, for example, may be prevented.

In the sheet inverting and ejecting path 309, into which the sheet 100 is sent from the sheet-inverting unit 4, a conveying roller 148 having at least a surface composed of a conductive elastic member is deployed to act as a rotary sheet conveyor similar to the conveying roller 136. A driven roller 149 that is driven by the conveying roller 148, is positioned as a driven rotated member able to engage and disengage with the conveying roller 148 in a direction as show by arrow (D) in FIG. 4. The conveying roller 148 is accordingly located on the downstream side of the sheet conveying belt 31.

To eject the sheet 100 fed out from either the sheet inverting and ejecting path 309 and the straight sheet ejecting path 306 onto the sheet-exiting tray 104, a conveying roller 143 (i.e., a sheet exit roller) at least having a surface composed of a conductive elastic member is positioned as a rotary conveyor similar to the conveying roller 136. A driven roller 144 that is driven by the conveying roller 143 provides a driven rotation member and is positioned to engage and disengage the conveying roller 143. The conveying roller 143 is located on the downstream side of the sheet conveying belt 31.

On the downstream side of the conveying roller 143 and the upstream side of the sheet exit tray 104, an electric charge removing device 146 (e.g., an electric charge removing brush) is disposed to remove an electric charge remaining on the sheet 100 being discharged. Specifically, the electric charge removing device 146 is provided to eject the sheet 100 onto the sheet-exiting tray 104 while removing the electric charge applied to the sheet 100 by the pressing roller 38 that acts as an electric charge applying device.

As illustrated in FIG. 4, the driven roller 144 is held by a link 147 capable of swinging between two positions as shown by solid and broken lines in a direction as shown by arrow (D). Specifically, the link 147 is swingable around a rotation fulcrum 147a that rotatably supports the driven roller 144 around a holding fulcrum 147b. The link 147 is pivoted by a driving mechanism (not shown).

Respective mechanisms to engage and disengage the above-described driven rollers 137 and 149 with respective driving rollers are similarly configured as in the above-described mechanism.

In the double-sided sheet conveying path 304, various conveying rollers, such as a conveying roller 138a, a driven roller 138b, a conveying roller 139a, a driven roller 139b, a conveying roller 140a, and a driven roller 140b, for example, are arranged.

The conveying rollers (138a, 139a, and 140a) each serve as a rotary conveyor at least having a surface composed of a conductive elastic member similar to the conveying roller 136. The conveying rollers (138a, 139a, and 140a) are located on the downstream side of the sheet conveying belt 31. An engaging and disengaging mechanism that engages and disengages each of the driven rollers (138b, 139b, and 140b) with respective conveying rollers (138a, 139a, and 140a), includes the same mechanism as the above-described mechanism that engages and disengages the driven roller 144. Further, the duplex sheet conveying path 304 is used to re-feed the sheet 100 sent thereto toward the pair of registration rollers 134.

The sheet feeding unit 20 is detachably attached to the apparatus body 10 at a front side thereof. The sheet feeding unit 20 includes a sheet feeding cassette 103 to stack and accommodate multiple sheets 100, and a pickup roller 141 to separate and feed the multiple sheets 100 stored in the sheet feeding cassette 103 one by one. The sheet feeding unit 20 also includes a pair of conveying rollers 132.

The sheet feeding unit 20 includes a straight manual sheet feeding tray 105 to be manually used, the pickup roller 141 to pick up and feed the sheet 100 one at a time from the straight manual sheet feeding tray 105, and a pair of conveying rollers 142.

Further, the processing liquid application system 400 includes a deformable bag-shaped processing liquid container, e.g., made of a PET (Poly Ethylene Terephthalate) film (not shown) to contain processing liquid 401 therein, and a pump (not shown) to feed the processing liquid 401 with pressure, when it is supplied from the processing liquid containers. The processing liquid application system 400 also includes a coating unit 410 to coat the sheet 100 acting as a printing medium with the processing liquid 401 or the like. Specifically, the pump pumps up the processing liquid 401 stored in the processing liquid containers, and supplies it to a liquid chamber 402 provided in a coating unit 410 via a supply path (not shown) to prepare for coating of the processing liquid 401.

A liquid level detector (not shown) installed in the liquid chamber 402 detects and confirms that a height of the liquid level and an angle of the liquid plane of the processing liquid 401 supplied to the liquid chamber 402 are within given levels, respectively. The liquid level detector may be an electrode pin system, for example. The electrode pin system is known and is not described in detail here, but detects the liquid level by supplying electricity to electrode pins through the liquid and checking an electrical conductive level between the electrode pins. In this way, a lack of or excessive supplying of the processing liquid 401 more than a prescribed amount to the liquid chamber 402 can be checked and reduced.

The coating unit 410 includes a conveying roller 434 that conveys the sheet 100, a coating roller 432 opposed to the conveying roller 434 to coat the sheet 100 with the processing liquid 401, and a squeeze roller 433 to supply the processing liquid 401 to the coating roller 432 while thinning the processing liquid 401 as a liquid film thereof.

The coating roller 432 is positioned to contact the conveying roller 434. By contrast, the squeeze roller 433 is positioned to contact the coating roller 432. Accordingly, a liquid film layer of the processing liquid 401 is formed on the coating roller 432 when it is supplied by the squeeze roller 433 and the coating roller 432, and conveyed and applied to the sheet 100 as the coating roller 432 rotates in a prescribed direction.

It is to be noted that the processing liquid 401 serves as quality modification material to modify the quality of the surface of the sheet 100 when applied to the surface of the sheet 100. For example, the processing liquid 401 serves as a fixative (e.g., a setting agent) when uniformly coated onto the sheet 100 in advance, because water in the ink is urged to quickly penetrate into the sheet 100 and a color component of ink is thickened while hastening the ink to dry to avoid blurring (e.g., feathering, bleeding, etc.) and striking through of the ink to a rear surface of the sheet, so that the productivity (number of images outputted per unit of time) can be enhanced.

As a chemical composition of the processing liquid 401, solution prepared by adding both cellulose (hydroxypropyl cellulose, for example,) that promotes penetration of moisture and a base agent such as talc fine powder, for example, to surfactants (e.g., anion, cationic, nonionic, and mixture of two or more of these, for example) is used in exemplary embodiments of the disclosure. The chemical composition can further contain fine particles.

The sheets 100 housed in the sheet feeding cassette 103 are separated and fed one at a time by a pickup roller 131 and sent by a pair of conveying rollers 133 to the pair of registration rollers 134. Subsequently, the sheet 100 is sent from the pair of registration rollers 134 at a predetermined time toward the processing liquid coating unit 400 along a sheet conveying path 300. The processing liquid 401 is then coated onto the sheet 100 by the process fluid coating unit 400.

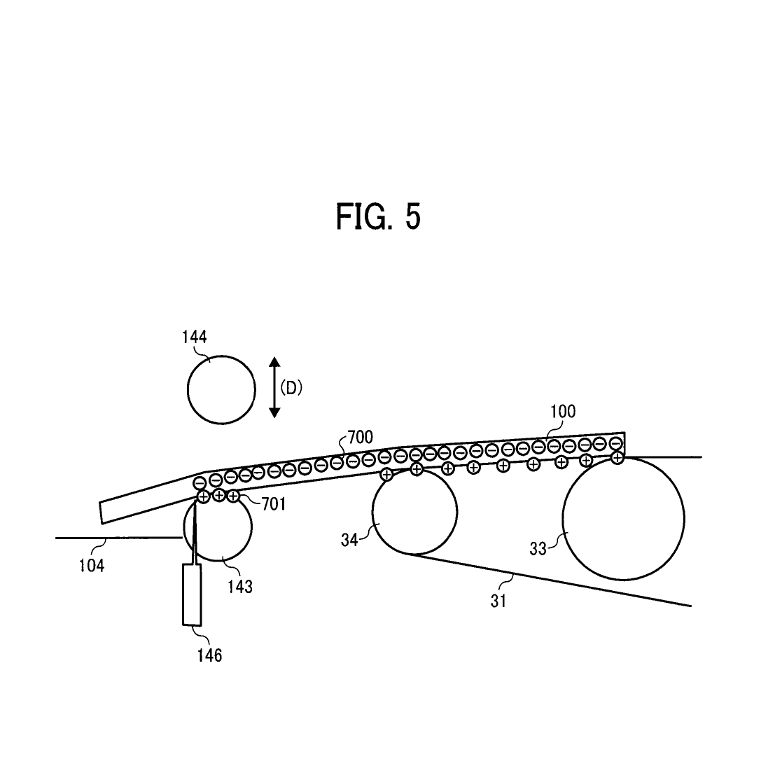

Now, an attraction principle of the conveying roller attracting a sheet thereto as a rotary conveyor in the image forming apparatus is described with reference to FIG. 5 and applicable drawings. Here, only the conveying roller 143 is mainly described. However, each of the other conveying rollers (136, 148, and 138a to 140a) has substantially the same configuration and executes substantially the same operation as well.

Since the DC voltage (or an AC voltage superimposed DC voltage) is supplied to the pressing roller 38 as described above, a negative (−) electric charge 700, for example, is applied onto the surface of the sheet 100 (e.g., an image forming surface) sandwiched between the sheet conveying belt 31 and the pressing roller 38. Since a positive (+) electric charge 701 appears on the sheet conveying belt 31 due to electrostatic induction when the negative charge 700 is applied onto the sheet 100, the sheet 100 may be attracted by the sheet conveying belt 31 thereonto by Coulomb force.

At this moment, an attraction force may be further enhanced by previously applying a positive electric charge onto the sheet conveying belt 31 using the pair of electric charging rollers 39a and 39b.

As a result, an image is formed on the sheet 100 by the image forming head 2 while the sheet 100 is secured to and intermittently conveyed by the sheet conveying belt 31 as the sheet conveying belt 31 circulates. Subsequently, as illustrated in FIG. 5, the sheet 100 with the image thereon is separated due to curvature of the separating roller 34 from the sheet conveying belt 31.

The sheet 100 separated from the sheet conveying belt 31 is conveyed toward the conveying roller 143 composed of an electrically conductive elastic member. Since a vertex of the conveying roller 143 is lower than a sheet conveying surface formed by the sheet conveying belt 31, the sheet 100 is hardly peeled off from both the conveying roller 143 and the sheet conveying belt 31, even after the sheet 100 is attracted onto the conveying roller 143. The negative electric charge 700 has been applied onto the sheet 100, and a positive electric charge 701 is electrostatically generated on the surface of the conveying roller 143 composed of an electrically conductive elastic member. Since the negative electric charge 700 in the sheet 100 and the positive electric charge 701 in the conveying roller 143 attract each other, the sheet 100 is attracted onto the conveying roller 143 by the Coulomb force.

A contact area between the conveying roller 143 and the sheet 100 is apparently smaller than that between the sheet conveying belt 31 and the sheet 100, and a stronger sheet attraction force is needed to constantly convey the sheet 100 than when it is conveyed by the sheet conveying belt 31. In this regards, it is necessary to raise the electric attraction force of the conveying roller 143 having a different construction from the sheet conveying belt 31. The sheet conveying belt 31 is a two-tier structure composed of an insulating layer on its surface and a resistance controlled (conductive) layer with its resistance controlled by carbon on its backside. On the other hand, the surface of the conveying roller 143 is composed of a conductive member.

The sheet 100 attracted onto the conveying roller 143 is then sent and ejected onto the sheet-exiting tray 104 by the conveying roller 143.

A charge removing device 146 is positioned between the conveying roller 143 and the sheet-exiting tray 104 to remove the negative electric charge 700 remaining on the sheet 100, the sheet 100 can exit onto the sheet-exiting tray 104 without bearing the negative electric charge 700 thereon. Accordingly, multiple sheets 100 exiting onto the sheet-exiting tray 104 are likely to avoid sticking to each other due generally to the electrostatic charge remaining thereon.

Heretofore, in this embodiment, the conductive elastic member is employed as the exemplary rotary conveyor, because it has a relatively high friction coefficient, a large adsorption force, and is prepared at a low cost. However, the present disclosure is not limited thereto, and a similar conveying force can be also obtained by utilizing a belt or a roller at least having a surface composed of a conductive member as well.

Now, with reference to FIG. 1, an aspect of when the sheet 100 bearing the image formed in the image forming head 2 is linearly ejected onto the sheet-exiting tray 104 is described.

As described earlier, the sheet 100 coated with the processing liquid 401 is conveyed into the sheet conveying path 305 via the pair of conveying rollers 145. Subsequently, in the sheet conveying path 305, the sheet 100 is fed onto the sheet conveying belt 31, in which a DC electric field is formed. The sheet 100 is then given an electric charge having a reverse polarity to that of the sheet conveying belt 31 by the pressing roller 38. Consequently, the sheet 100 is electrostatically attracted onto the sheet conveying belt 31 and is held thereon.

Then, the printing head 24 is driven based on an image signal while moving the carriage 23 with respect to the sheet 100 and executes printing on the sheet 100 by ejecting droplets thereon to form an image of one line when the sheet 100 reaches and stops at a starting position for starting image formation. When one line printing is completed, the sheet 100 is sent by an amount of one line to execute printing on the next line. Thus, by intermittently conveying the sheet 100, an image is sequentially formed on the sheet 100 (line by line). When receiving either a signal indicating that printing is completed or that the end of sheet 100 has reached an end of a printing region, the printing is terminated.

The separating roller 34 is moved to a position as shown by the broken line in FIG. 1 (a position as shown by the solid line in FIG. 4), at the latest, before the tip of the sheet 100 in the process of image formation reaches the conveying roller 33.

By this, the sheet 100 bearing the image is conveyed and is attracted and further conveyed by the conveying roller 143 along the straight sheet ejecting path 306 as the sheet conveying belt 31 moves and circulates. The sheet 100 bearing the image finally exits onto the sheet-exiting tray 104 with the printing surface facing upward. Further, also in this situation, as described earlier, since the electric charge is applied onto the sheet 100, an electric charge having a reverse polarity to that of the sheet 100 is excited (generated) on the conveying roller 143, and the sheet 100 is electrostatically attracted thereon and is further conveyed by the conveying roller 143.

Now, an exemplary operation executed when the sheet 100 bearing the image formed in the image forming head 2 is inverted and is ejected onto the sheet-exiting tray 104 in the image forming apparatus is described.

Specifically, similar to the situation in which the sheet 100 is linearly ejected, the printing head 24 is driven based on an image signal while moving the carriage 23 with respect to the sheet 100 and executes printing on the sheet 100 by ejecting droplets thereon to form an image of one line when the sheet 100 reaches and stops at a starting position for starting image formation. When the one line is printed, the sheet 100 is sent by an amount of one line to execute printing on the next line. Thus, by intermittently conveying the sheet 100, an image is sequentially formed on the sheet 100 (line by line). When receiving either a signal indicating that the printing is completed or indicating that the end of sheet 100 reaches the end of a printing region, the printing is terminated.

The separating roller 34 is moved to a position as shown by the solid line in FIG. 1, at the latest, before the tip of the sheet 100 in the process of image formation reaches the conveying roller 33.

By this, the sheet 100 bearing the image formed in this way is subsequently conveyed and diagonally sent downward and is further sent into the sheet-inverting unit 4 through the sheet inverting path 311 by the sheet conveying belt 31 as it circulates.

Since an electric charge has been given to the sheet 100, an electric charge having a reverse polarity to that of the sheet 100 is excited (generated) in the conveying roller 136 as described earlier, and the sheet 100 is electrostatically attracted and conveyed by the conveying roller 136, and taken in by the sheet-inverting unit 4.

Further, the sheet 100 conveyed into the sheet-inverting unit 4 subsequently evacuates from the sheet-inverting unit 4 as the conveying roller 136 reversely rotates. At this moment, a path switching nail 41 is located at a position as shown by a solid line in the drawing, and accordingly, the sheet 100 fed out by the conveying roller 136 is conveyed toward the sheet inverting and ejecting path 309.

In the sheet inverting and ejecting path 309, since the electric charge has been applied to the sheet 100, an electric charge having a reverse polarity to that of the sheet 100 is applied to the conveying roller 148 as described earlier. Thus, the back side of the sheet 100 opposite a front side bearing the image formed in this way, is electrostatically attracted by the conveying roller 148 and is thereby conveyed downstream.

The sheet 100 is subsequently sent to the conveying roller 143 from the sheet inverting and ejecting path 309. Subsequently, since the electric charge is given to the sheet 100, and an electric charge having a reverse polarity to that of the sheet 100 is excited in the conveying roller 143 as described earlier, the sheet 100 is electrostatically attracted and conveyed by the conveying roller 143. The sheet 100 consequently exits onto the sheet-exiting tray 104 with its printing surface facing down.

Since the conveying roller 143 is also used in executing the straight sheet ejection, the conveying roller 143 attracts the image printed surface of the sheet 100 when the sheet inverting and ejecting process is executed. However, since the sheet 100 passes through the sheet-inverting unit 4 in the sheet inverting and ejecting process, an ink drying and settling time can be relatively sufficiently ensured before the sheet 100 reaches the conveying roller 143, and accordingly, the ink almost never adheres to the conveying roller 143.

By supposing that the sheet 100 having a property of poor ink drying fixative is conveyed, the driven roller 144 positioned in a location opposed to the conveying roller 143 can also be composed of a conductive elastic member as well, so that the sheet 100 can be attracted onto the driven roller 144 and conveyed in the sheet inverting and ejecting process.

All of the conveying rollers placed downstream of the sheet conveying belt 31, while facing the back side of the sheet 100, are not necessarily conductive to attract the sheet 100. Further, only some of the conveying rollers need to be conductive to attract the sheet 100 as well. In particular, a prescribed conveying roller disposed closer to the sheet conveying belt 31 is preferably enabled to attract the sheet 100.

Now, an operation of forming multiple images on both sides of the sheet 100 respectively is described.

As described above, the sheet 100 coated with the processing liquid 401 is conveyed to sheet conveying path 305 via the pair of rollers 145. In the sheet conveying path 305, the sheet 100 is fed onto the sheet conveying belt 31, in which a DC electric field is formed. The sheet 100 is subsequently given an electric charge having a reverse polarity to that of the sheet conveying belt 31 by the pressing roller 38. Accordingly, the sheet 100 can be electrostatically attracted onto the sheet conveying belt 31 and is held thereon.

Then, the printing head 24 is driven based on an image signal while moving the carriage 23 with respect to the sheet 100 and executes printing on the sheet 100 by ejecting droplets thereon to form an image of one line when the sheet 100 reaches and stops at a starting position for starting image formation. Hence, by intermittently conveying the sheet 100, an image is sequentially formed on the sheet 100 (line by line). When the one line is printed, the sheet 100 is sent by one line to execute printing on the next line. When receiving either a signal indicating that the printing is completed or indicating that the end of sheet 100 reaches the end of a printing region, the printing is terminated.

The separating roller 34 is moved to a position as shown by the solid line in FIG. 1, at latest, before the tip of the sheet 100 in the process of image formation reaches the conveying roller 33. As a result, the sheet 100 bearing the image formed in this way is subsequently conveyed and diagonally sent downwardly and is further sent into the sheet-inverting unit 4 through the sheet inverting path 311 by the sheet conveying belt 31 as it circulates.

Since the electric charge has been given to the sheet 100, and an electric charge having a reverse polarity to that of the sheet 100 is generated in the conveying roller 136 as described earlier, the sheet 100 is electrostatically attracted to and is conveyed by the conveying roller 136. The sheet 100 is subsequently taken in by the sheet-inverting unit 4. The sheet 100 conveyed into the sheet-inverting unit 4 subsequently evacuates from the sheet-inverting unit 4 as the conveying roller 136 reversely rotates. At this moment, a path switching nail 41 is located at a position as shown by a broken line in the drawing, and accordingly, the sheet 100 sent by the conveying roller 136 is conveyed toward the double-sided sheet conveying path 304. The sheet 100 is subsequently conveyed by multiple conveying rollers (138a, 139a, and 140a) and sent to the pair of registration rollers 134 again.

As described earlier, since the electric charge has been applied onto the sheet 100 again, and a reverse polarity to that in the sheet 100 is generated on the multiple conveying rollers (138a to 140a), the sheet 100 is electrostatically attracted thereon and further conveyed by these multiple conveying rollers 138a to 140a. Subsequently, the sheet 100 sent to the pair of registration rollers 134 is resent therefrom at a predetermined time toward the processing liquid coating unit 400 via the sheet conveying path 300. The processing liquid 401 is subsequently coated onto the other side (in which the image has not formed yet) of sheet 100 by the process fluid coating unit 400 as described above. Subsequently, after an image is formed on the other side of the sheet in the image forming head 2, the sheet 100 is further conveyed as the sheet conveying belt 31 shown by a broken line circulates and exits onto the sheet-exiting tray 104 along the straight sheet ejecting path 306, with its printing side facing upward as the conveying roller 143 rotates.

Now, an operation of a straight sheet ejection process in which the sheet 100 is almost linearly fed and conveyed from the manual sheet feeding tray 105 is described.

Specifically, by using the manual sheet feeding tray 105, an image can be easily formed on a special sheet, such as cardboard, or a sticker release paper sheet, for example. A path extended from the manual sheet feeding tray 105 joins the sheet conveying path downstream of the processing liquid coating unit 400 in the conveying direction, a sheet such as a coated sheet, for example, not requiring coating of the processing liquid is preferably fed from the manual sheet feeding tray 105 as well. For this reason, the manual sheet feeding tray 105 is enabled to load several sheets thereon while enabling the pickup roller 141 to pick up and supply the sheets 100 one at a time.

Specifically, the sheets 100 housed in the manual sheet feeding tray 105 are separated and fed one at a time by the pickup roller 141, and conveyed by the conveying roller 142 toward the printing sheet conveying path 305. Subsequently, as described above, the sheet 100 is intermittently conveyed by the sheet conveying belt 31 again, and an image is formed thereon in the image forming head 2. Subsequently, the sheet 100 bearing the image is further conveyed as the sheet conveying belt 31 shown by a broken line circulates and exits onto the sheet-exiting tray 104 through the straight sheet ejecting path 306, with its printing side facing upward as the conveying roller 143 rotates.

Heretofore, a conveying operation of the multiple driven rollers 137, 149, 144, and 138b to 140b ha not been described. However, as described earlier, in accordance with a sheet type and environmental conditions (such as temperature, humidity, for example) or the like, the driven rollers (137, 149, 144, and 138b to 140b) are moved to contact the respective conveying rollers (136, 148, 144, and 138a to 140a) to press the sheet 100 thereagainst.

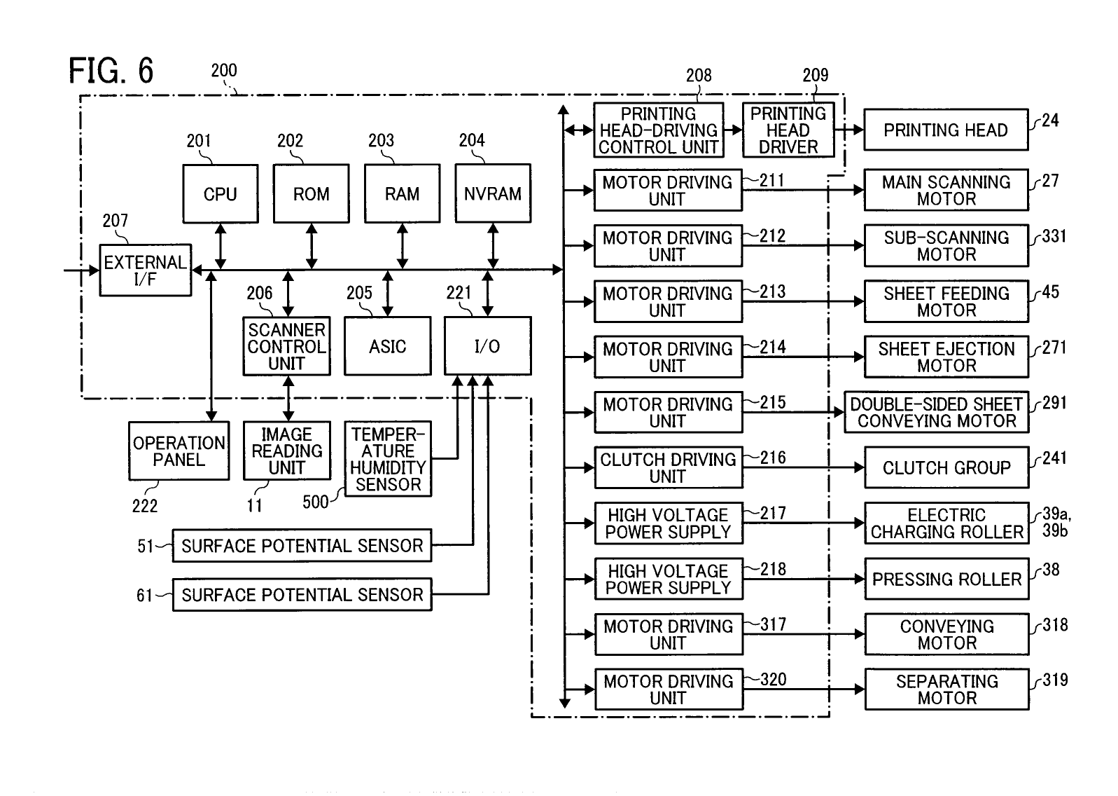

Now, an overview of a controller provided in the image forming apparatus is described with reference to FIG. 6.

Specifically, the controller 200 is comprised of a CPU (central processing unit) 201 that generally controls the image forming apparatus, a ROM (read only memory) 202 that stores programs and the other fixed data implemented by the CPU 201, and a RAM (random access memory) 203 that temporarily stores image data (printing data), for example.

The controller 200 also includes a non-volatile memory (NVRAM) 204 that holds data even when a power supply is interrupted. Further, the controller 200 includes an ASIC (application specific integrated circuit) 205 that applies various signal processes to image data, executes image forming processes such as sorting, for example, and handles input and output signals other than those of processes to generally control the image forming apparatus.

Further, the controller 200 also includes a scanner control unit 206 that controls an image reading unit 11 to read an image and processes image data read by the image reading unit 11 and so forth.

An external I/F 207 (Interface) of the controller 200 used to receive data from an external device is enabled to send and receive data and signals. A printing head-driving control unit 208 and a printing head driver 209 of the controller 200 collectively control the printing head 24 included in the image forming head 2 to operate.

Further, included in the controller 200 are a motor driving unit 211 that drives a main scanning motor 27 to execute main scanning of the carriage 23, and a motor-driving unit 212 that drives the sub-scanning motor 331 to rotate the conveying roller 32 and accordingly circulate the sheet conveying belt 31. A motor driving unit 213 drives a sheet feeding motor 45, and a motor driving unit 214 that drives a sheet ejection motor 271 to operate and rotate various rollers, such as the sheet conveying roller 143, for example, are provided.

A motor driving unit 215 of the control unit 200 that drives a double-sided sheet conveying motor 291 to drive and rotate various rollers located in a duplex sheet conveying path 304, and a motor-driving unit 317 that drives a conveying motor 318 to drive and rotate the conveying roller 136 located in the sheet-inverting unit 4.

The controller 200 includes a motor driving unit 320 that drives a separating motor 319 to move the separating roller 34.

The controller 200 further includes a clutch driving unit 216 that drives a clutch group 241. The clutch group 241 includes multiple sheet feeding-electromagnetic clutches that independently drive and rotate the pickup roller 131 and the pair of conveying rollers 132, and the pickup roller 141 and the pair of conveying rollers 142, respectively. Further, the clutch group 241 includes an electromagnetic clutch that independently drives the sheet conveying paths and a path switching plate solenoid that pivots the path switching nail 41 to switch the sheet conveying path.

The controller 200 includes the high voltage power supply 217 that supplies a high voltage to the pair of electric charging rollers 39a and 39b. The high voltage power supply 217 can independently control each of the high voltages applied to the pair of electric charging rollers 39a and 39b, respectively.

The controller 200 includes a high voltage power supply 218 that supplies a high voltage to the pressing roller 38.

The controller 200 also includes an I/O (Input and Output port) 221 that captures detection signals from various sensors. Specifically, a detection signal is inputted to the I/O 221 from the temperature humidity sensor 500 that detects temperature and humidity as an environmental condition. Also inputted to the I/O 221 are detection signals from an image formation starting sensor (not shown) and an image formation end sensor (not shown). Further, measuring signals from the respective surface potential sensors 51, 61 are inputted to the I/O 221.

Further, an operation panel 222 is connected to the controller 200 to input and display information necessary for the apparatus.

Accordingly, the controller 200 processes and stores read image data in a buffer included in the scanner control unit 206 when the image reading unit 11 reads an image of an original document. By contrast, the controller 200 stores printing data or the like in a buffer included in an external I/F 207 upon receiving it from an external host, such as an information processing device (e.g., a personal computer), an image reader (e.g., an image scanner), or an imaging device (e.g., a digital camera), for example, via the external I/F 207.

The CPU 201 reads image data from the scanner control unit 206 or the external I/F 207, and analyzes the image data. The ASIC 205 then executes necessary image processing and data reordering processing or the like and transfers printing image data to a printing head-driving control unit 208. Here, dot pattern data for outputting an image based on data sent from the external device can be generated by storing font data in the ROM 202, for example. Otherwise, image data can be spread as bitmap data by a printer driver provided in the external host, and is transferred to the image forming apparatus.

Upon receiving the image data (e.g., the dot pattern data) corresponding to one line of each printing head of the printing head 24, the printing head-driving control unit 208 transfers the one line dot pattern data to a printing head driver 209. Based on the dot pattern data, the printing head driver 209 selectively provides a driving waveform and drives an actuator included in the printing head 24 and lets a prescribed nozzle of the printing head of the of the printing head 24 discharge a droplet therefrom.

As a result, in the image forming apparatus configured in this way, the sheet 100 is fed one by one from either the sheet feeding unit 20 or the double-sided sheet conveying path 310 and is pressed against the sheet conveying belt 31 by the pressing roller 38. As a result, a conveying direction of the sheet 100 is changed by an angle of about 90°. The sheet 100 is then electrostatically attracted onto the sheet conveying belt 31 and further conveyed in the sub-scanning direction as the sheet conveying belt 31 circulates.

Then, the printing head 24 is driven based on an image signal and executes printing an image of one line on the sheet 100 which is currently stopped, by ejecting a droplet thereonto while moving the carriage 23. When one line printing is completed, the sheet 100 is sent by one line to execute printing on the next line. In this way, by intermittently conveying the sheet 100, an image is sequentially formed on the sheet 100 (e.g., line by line).

Upon receiving either a signal indicating that the printing is completed or indicating that the end of sheet 100 reaches the end of a printing region, the printing is terminated.

At this moment, by moving the separating roller 34 between positions in accordance with usage of the sheet conveying path as shown by solid and broken lines in FIGS. 1 and 4 as described above, the sheet conveying path for conveying the sheet 100 bearing the image is switched. The sheet 100 is accordingly sent onto the sheet-exiting tray 104 via a prescribed conveying path.

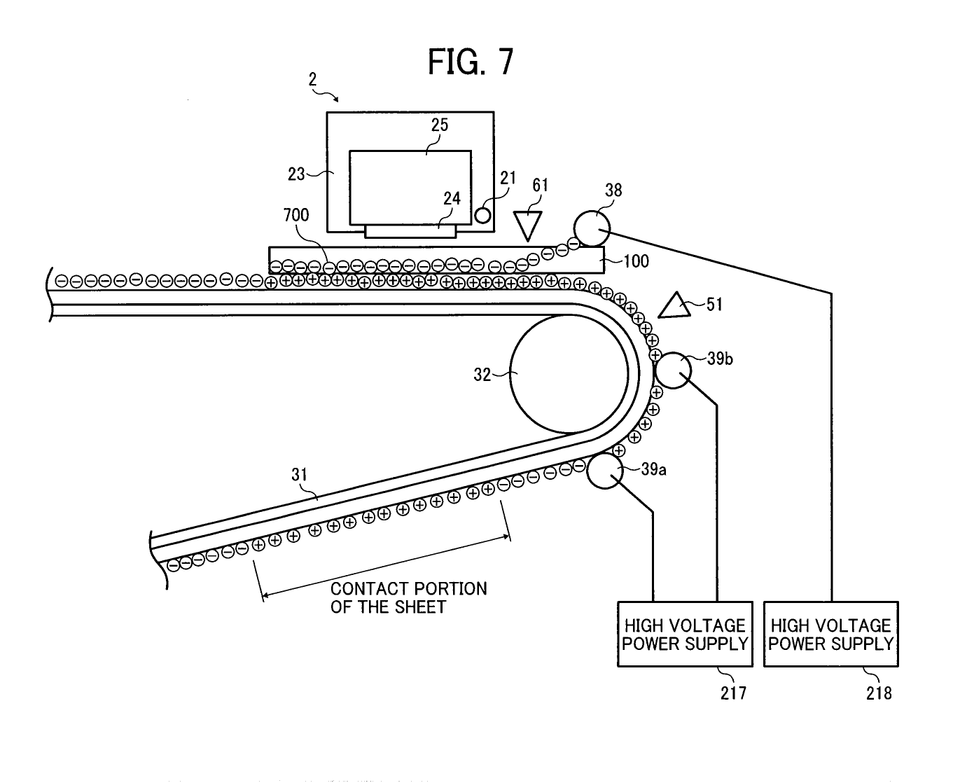

Charging control applied to the sheet 100 via control of power supplying to the pressing roller 38 according to an embodiment of the present disclosure is described with reference to FIG. 7.

FIG. 7 is a diagram illustrating a charged state of each of the sheet 100 and the conveying belt 31 when charging control is implemented thereon via control of power supplying to the pressing roller 38.

Initially, as shown in FIG. 7, the high voltage power supply 217 provides a high voltage to the electric charging roller 39a. The electric charging roller 39a provides positive electric charge to the sheet conveying belt 31. Thus, the sheet conveying belt 31 bears the positive electric charge thereon. Similarly, the high voltage power supply 217 supplies a high voltage to the electric charging roller 39b. The electric charging roller 39b then supplies the positive electric charge to the sheet conveying belt 31 to electrically positively charge the sheet conveying belt 31 uniformly so that it bears the positive electric charge thereon.

Thus, with electric charging rollers 39a and 39b, the sheet conveying belt 31 is charged with the same polarity electric charge in two steps, and, finally is charged in the required amount of electric charges. Here, the number of electric charging rollers is not limited to two; there may be more than two.

Such a positively charged state of the sheet conveying belt 31 is detected by the surface potential sensor 51. The control unit 200 subsequently adjusts the high voltage (the power supply voltage) supplied from the high voltage power supply 217 to at least one of electric charging rollers, preferably 39b based on the detection result to render the surface potential to be a given value.

By contrast, the sheet 100 is conveyed onto the sheet conveying belt 31 bearing the positive electric charge thereon. At this moment, by receiving the negative electric charge 700, the sheet 100 is negatively electrically charged by the pressing roller 38 to which a high voltage is supplied from the high voltage power supply 218.

By negatively charging the sheet 100 from above the sheet 100, since the electric charge on the sheet 100 and that on the sheet conveying belt 31 are balanced, the surface potential on the sheet 100 can be reduced.

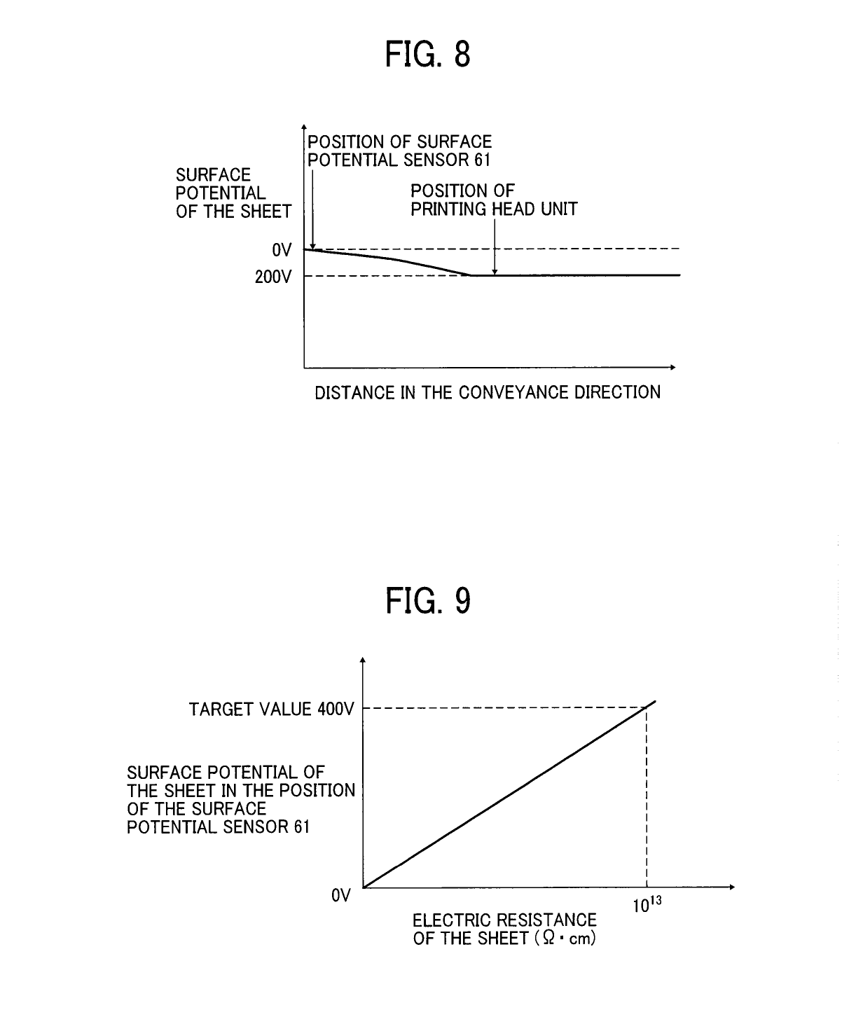

Next, a change of the surface potential of the sheet 100, which arises between locations along an image forming conveyance path 301 corresponding to positions of the surface potential sensor and the printing head 24, is described with reference to FIG. 8.

As a result of the electrical resistance of the sheet 100, the negative electric charge 700 borne thereon takes a prescribed time to reach a back side of the sheet 100. In particular, in a low temperature and low humidity environment, since the electrical resistance of the sheet 100 is relatively high, such as 10¹² Ω-cm for example, and the negative electric charge 700 moves slowly, the surface potential of the sheet 100 when the sheet is near the surface potential sensor 61 is different than when the sheet 100 is below the printing head 24 as shown in FIG. 8.

During operation, a positive surface potential of about 200V is produced on the surface of the sheet 100 along the image forming conveyance path 301 because the negative electric charge 700 on the surface of the sheet 100 moves toward the sheet conveying belt 31 until the sheet 100 arrives at the location along the image forming conveyance path 301 corresponding to the position of the printing head 24. This is the case, even if the surface potential of the sheet at the location corresponding to the position of the surface potential sensor 61 is 0V as shown in FIG. 8.

Therefore, it is necessary to take this charge transfer into account, and maintain the surface potential of the sheet 100 at the location corresponding to the position of the surface potential sensor 61 at an amount so the surface potential at the location corresponding to the position of the printing head 24 is approximately 0V.

The charge transfer is affected by the electrical resistance of the sheet 100 as described above. In addition, it is advantageous to measure the electrical resistance of the sheet just before a printing operation, in order to account for the influence of the environmental transformation such as temperature and humidity, or of the moisture content resulting from storage environment.

Therefore, in this embodiment, the electrical resistance of the sheet 100 is estimated or calculated using a value measured with the surface potential sensor 61 just before the printing operation.

In other words, if the applied voltage to the sheet conveying belt 31 (the first applied voltage) and the applied voltage to the sheet 100 (the second applied voltage) are fixed values, a transfer speed of the negative electric charge 700 can be estimated or calculated by a value measured with the surface potential sensor 61. This is because the speed of the sheet 100 from the pressing roller 38, which applies the voltage to the sheet 100, to the surface potential sensor 61, is constant. In addition, if the transfer speed of the negative electric charge 700 is known, the electrical resistance of the sheet 100 can be calculated.

Then, the electrical resistance of a subsequent sheet 100 can estimated or calculated by referring to the value of the second applied voltage applied to a previous sheet 100, if the second applied voltage is changed according to a type of the subsequent sheet 100, for example.

Moreover, if the electrical resistance of the sheet is known, a difference of the surface potential of the sheet 100 between the locations corresponding to the positions of the surface potential sensor 61 and the position of the printing head 24 can be predicted. In other words, adjustment to 0V of the surface potential of the sheet in the position of the printing head 24 is enabled by deciding a value (the target value) of the surface potential of the sheet in the position of the surface potential sensor 61 based on the predicted difference of the surface potential.

An example of the relationship between the electrical resistance of the sheet 100 and the target value of the surface potential (target value) of the sheet 100 at the location corresponding to the position of the surface potential sensor 61, in order for the surface potential at the location corresponding to the position of a printing head 24 to 0V, is illustrated in FIG. 9. In addition, the value of the applied voltage to the sheet conveying belt 31 (the first applied voltage) is 2000V, and the value of the applied voltage to the sheet 100 (the second applied voltage) is 3000V in FIG. 9. The value of the surface potential of the sheet at the location corresponding to the position of the surface potential sensor 61 determined using the electrical resistance of the sheet 100 that is estimated or calculated. If the electrical resistance of the sheet is 10¹³ (Ω-cm), the surface potential of the sheet at the location corresponding to the position of the printing head 24 can be 0V by if the surface potential of the sheet 100 is 400V at the location corresponding to the surface potential sensor 61 as shown in FIG. 9. Thus, the applied voltage to the pressing roller 38 is controlled so that the value of the surface potential of the sheet at the location corresponding to the position of the surface potential sensor 61 becomes 400V. Thereby, the value of the surface potential of the sheet 100 at the location corresponding to the position of the printing head 24 can be reliably adjusted to be 0V, without requiring the surface potential sensor 61 to be positioned under the printing head 24 to measure the surface potential of the sheet 100.

The first applied voltage and the second applied voltage are generally fixed for each of the pressing roller 38, and the pair of the electric charging rollers (39a, 39b). Therefore, the relationship between the target value of the surface potential of the sheet 100 at the location corresponding to the position of the surface potential sensor 61 and the measured value of the surface potential first measured with the surface potential sensor 61, may be previously measured and stored in a data table. Using this data table, the target value can be determined based on the value of the second applied voltage and the measured value of the surface potential by the surface potential sensor 61 directly, without calculating the electrical resistance of the sheet.

Moreover, if the second applied voltage is changed according to a type of sheet as described above, relationships between the target value of the surface potential of the sheet at the location corresponding to the position of the surface potential sensor 61, the second applied voltage to the pressing roller 38, and the measured value of the surface potential first measured with the surface potential sensor 61, may be measured and stored in a data table.

In this way, based on the measured value of the surface potential sensor 61, when the first applied voltage is applied to electric charging rollers 39a and 39b, and the second applied voltage is applied to the pressing roller 38, the target value of the surface potential of the sheet 100 at the location corresponding to the position of the surface potential sensor 61 is determined, and the second applied voltage to the pressing roller 38 is adjusted so that surface potential detected by the surface potential sensor 61 becomes the target value. Hereby, the electric field under the printing head 24 can be restrained and the degradation of image quality by a reverse flow of ink mist toward the printing head 24 can be prevented.

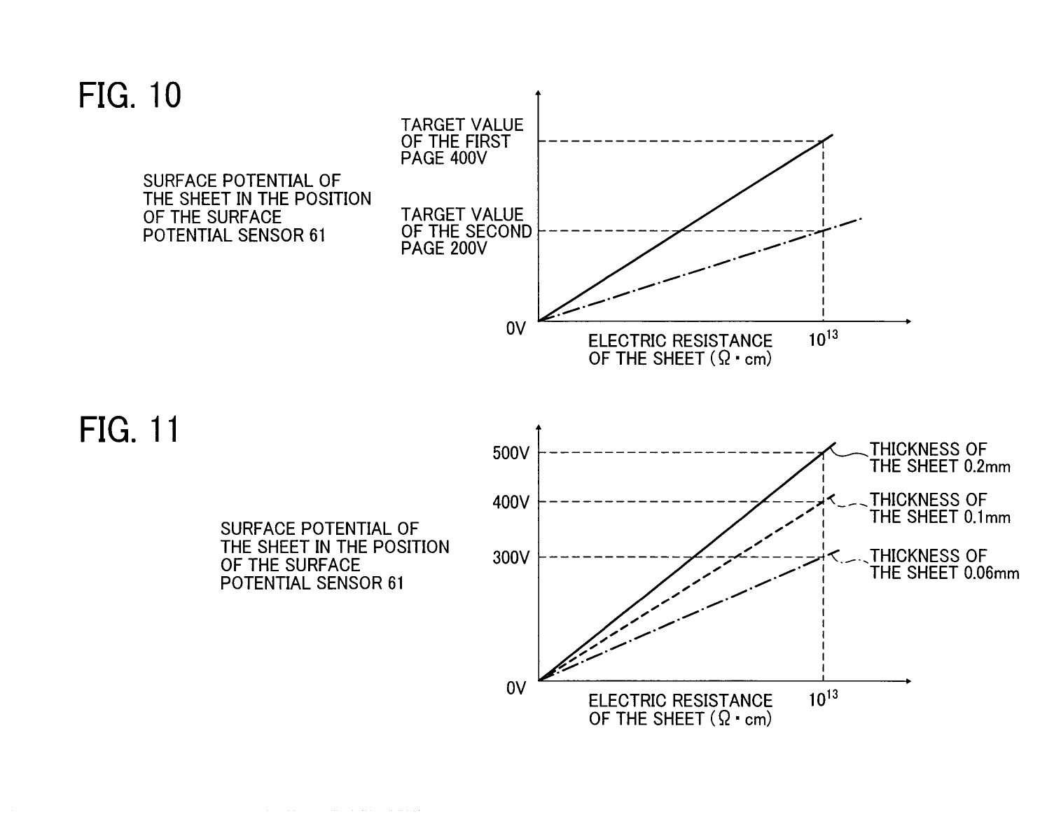

Next, the duplex printing operation of the image forming apparatus is explained with reference to FIG. 10. Further, in duplex printing, “the first page” is defined as a side of the sheet 100 on which an earlier image is formed and “the second page” is defined as a side of the sheet 100 on which a later image is formed. A solid line of FIG. 10 shows a relationship between an initial electrical resistance of the sheet (before printing the first page), and the target value of the surface potential of the sheet at the location corresponding to the position of the surface potential sensor 61 when the first page is printed. On the other hand, the dot-dash line of FIG. 10 shows the a relationship between the initial electrical resistance of the sheet (before printing the first page), and the target value of the surface potential of the sheet at the location corresponding to the position of the surface potential sensor 61 when the second page is printed.

In this case, the electrical resistance of the sheet 100 is estimated or calculated before printing the first page, and the target values of both the first page and the second page are determined based on the electrical resistance. The detection of the electrical resistance of the sheet 100 may be carried out just before printing the second page. However, it is desirable that the target value of the second page is decided using an electrical resistance before printing the first page, because the electrical resistance of the sheet 100 becomes uneven under the influence of ink that is used in printing the first page.

The target value of the second page is set to a value (200V in FIG. 10) that is lower than a target value of the first page (400V in FIG. 10). A time when the second page is printed, includes ink from printing the first page, and the electrical resistance of the sheet 100 is decreased from an electrical resistance that is detected before printing the first page. As a result, the electric charge on the second page of the sheet 100 moves more easily, even if surface potential is low.

Next, a relationship between the thickness of the sheet 100 and a target value of the surface potential of the sheet 100 at the location corresponding to the position of the surface potential sensor 61 is explained with reference to FIG. 11. Specifically, examples of the relationship according to the thickness of a sheet 100 between the electrical resistance of the sheet 100 and the surface potential (target value) of the sheet 100 at the location corresponding to the position of the surface potential sensor 61 so the surface potential at the location corresponding to the position of the printing head 24 is 0V, are shown in FIG. 11. The value of the applied voltage to the sheet conveying belt 31 (the first applied voltage) is 2000V, and the value of the applied voltage to the sheet 100 (the second applied voltage) is 3000V in FIG. 11.

When the electrical resistance of a sheet is 10¹³ (Ω-cm), if the thickness of the sheet is 0.2 mm, the target value of the surface potential of the sheet at the location corresponding to the position of the surface potential sensor 61 is set to 500V, and if the thickness of the sheet is 0.06 mm, the target value of the surface potential of the sheet 100 at the location corresponding to the position of the surface potential sensor 61 is set to 300V. Because it is difficult to move an electric charge in the sheet 100 from a surface facing the printing head 24 to a rear surface when the thickness of the sheet 100 is increased, it is necessary to set the target value of the surface potential to a higher value.

Therefore, adjustment to a more accurate surface potential is enabled by detecting thickness of the sheet 100, and determining the applied voltage for the pressing roller 38 based on the thickness of the sheet 100. In addition, a detection of the thickness of the sheet 100 may be judged from the input to the operation panel 222 of the image forming apparatus, or may be measured directly.

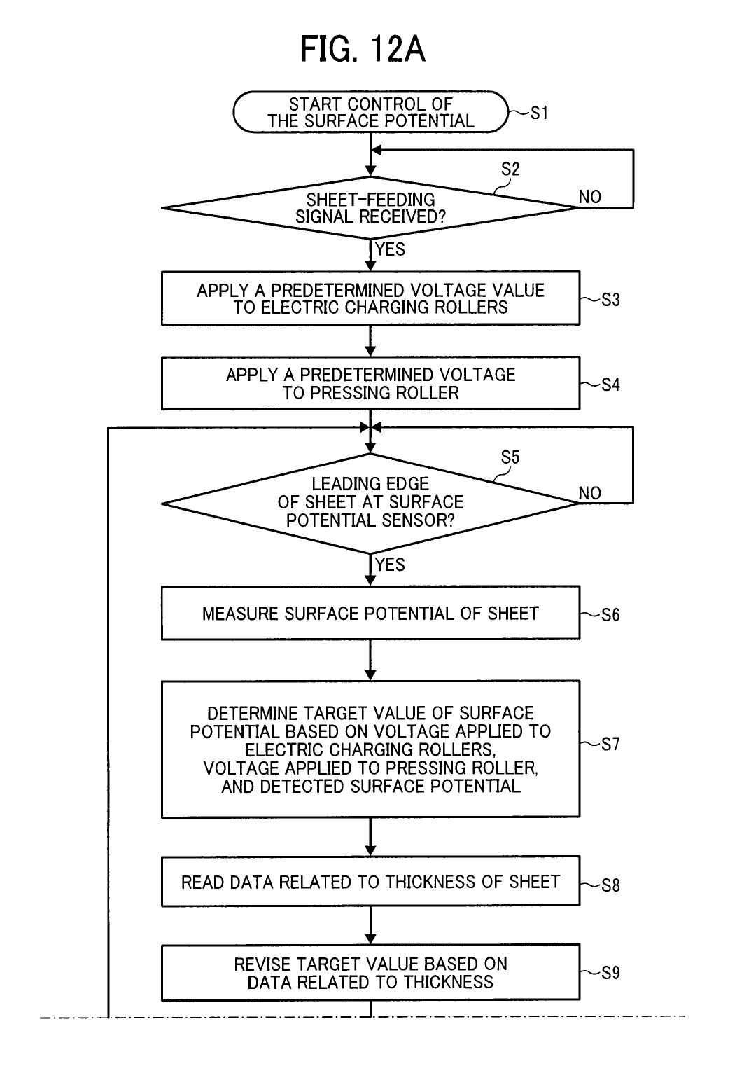

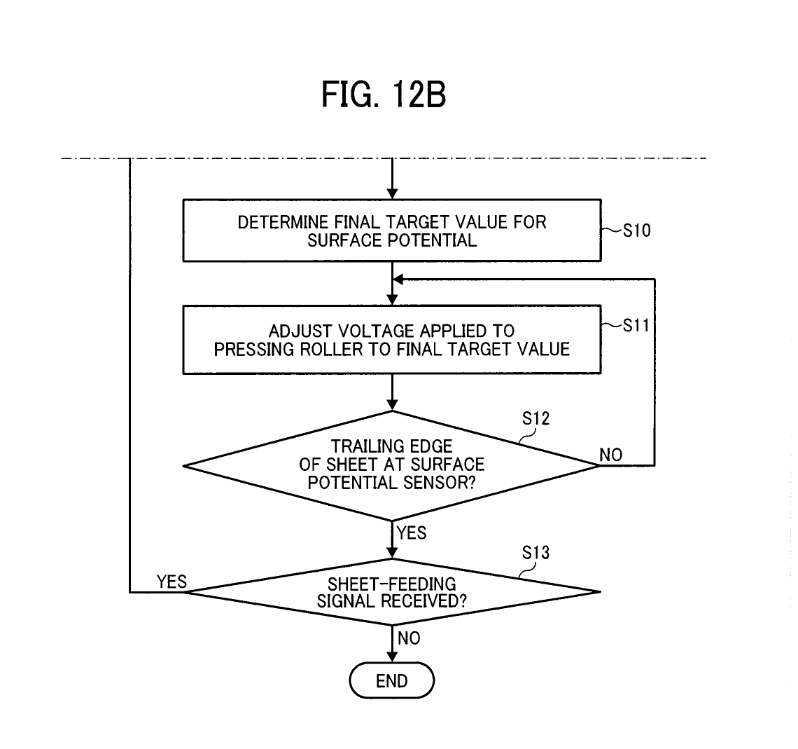

Next, an example of the surface potential control by the controller 200 is explained with reference to a flowchart in FIGS. 12A and 12B.

The control of the surface potential of the sheet is started (S1), then, upon receiving a sheet-feeding signal (S2), the controller 200 applies a predetermined voltage value (for example, 2000V) to electric charging rollers 39a and 39b(S3), which charge the sheet conveying belt 31, and applies a predetermined voltage value (for example, 3000V) (S4) to the pressing roller 38, which charges the sheet 100.

Next, it is determined if the leading edge of the sheet 100 reaches the surface potential sensor 61 (S5). If the leading edge has reached the surface potential sensor 61, the surface potential of the sheet 100 is measured using the surface potential sensor 61 (S6).

Then, the electrical resistance of the sheet 100 is estimated based on the predetermined voltage value applied to electric charging rollers 39a and 39b, the predetermined voltage value applied to the pressing roller 38, and a value of the surface potential measured by the surface potential sensor 61 (S7). Furthermore, with reference to a data table stored beforehand, the target value of surface potential of the sheet 100 at the location along the image forming conveyance path 301 corresponding to the position of the surface potential sensor 61 is determined so that surface potential of the sheet at the location along the image forming conveyance path 301 corresponding to the position of the printing head 24 becomes 0V.

The voltage value applied to the pressing roller 38 (the second applied voltage), the surface potential of the sheet 100 measured by the surface potential sensor 61, and the target value of the surface potential of the sheet 100 at the location corresponding to the position of the surface potential sensor 61 by which the surface potential of the sheet 100 at the location corresponding to the position of the printing head 24 becomes 0V, is stored in the data table. In addition, a correction value for the target value of the surface potential of the sheet based on information related to the thickness of a sheet 100 is also stored in the data table (S8).

If the applied voltage to electric charging rollers 39a and 39b and the applied voltage to the pressing roller 38 are fixed values and do not fluctuate, the target value of the surface potential of the sheet at the location corresponding to the position of the surface potential sensor 61 may be determined only based on a value of the surface potential measured by the surface potential sensor 61.

Next, the controller 200 reads the data about the thickness of a sheet that is detected or was stored beforehand (S8), the target value is revised based on the thickness of the sheet 100 (S9), and a final target value is determined (S10).

Then, the controller 200 controls the voltage applied to the pressing roller 38 the surface potential of the sheet 100 at the location corresponding to the position of the surface potential sensor 61 reaches the final target value (S11). The value of surface potential of the sheet 100 at the location corresponding to the position of the printing head 24 can be adjusted to 0V by the controlled voltage applied to the pressing roller 38 in this way.

Next, the controller 200 determines whether a trailing edge of the sheet 100 arrives at the location corresponding to the surface potential sensor 61 (S12), and controls a voltage applied to the pressing roller 38 until the trailing edge of the sheet 100 arrives at the surface potential sensor 61 so that surface potential of the sheet at the location corresponding to the position of the surface potential sensor 61, is remains at the final target value. If there is no sheet-feeding signal after the trailing edge of the sheet reaches the surface potential sensor 61 (S13), the control of the surface potential is ended.

The value of the voltage applied to the pressing roller 38 is controlled so that the surface potential of the sheet 100 at the location corresponding to the position of the printing head 24 is 0V as mentioned previously. However the value of the surface potential at the location corresponding printing head 24, for which the target value is determined in order to provide, is not limited to a value of 0V. Rather, the target value can be determined so the surface potential at the location corresponding to the position of the printing head 24 is a value that is sufficient to prevent a reverse flow of ink mist toward the printing head 24.

In the present disclosure, the material of the sheet is not limited to just paper and rather includes an OHP (overhead projector) sheet, cloth, glass, and a baseboard or the like. Further, the sheet includes material capable of attracting an ink drop and other liquid or the like, such as a direct printing medium, an indirect printing medium, a printing sheet, or a printing form, for example. Further, it is noted that in the present disclosure, image formation, recording, printing, imaging, and duplicating are used interchangeably.

It is also noted that the image forming apparatus represents a system that executes image formation by ejecting droplets onto a medium made of such as paper, yarn, fiber, fabric, leather, metal, plastic, glass, wood, and ceramics, for example. The image formation onto the medium includes forming specific images, such as a character or a figure, for example, as well as a non-specific image that is formed simply by landing droplets on a medium.

It is also noted that the ink is not particularly limited to so called ink unless particularly so described, and includes a DNA sample, resist, pattern material, and resin or the like. Specifically, the ink is a general term that represents liquid capable of forming an image, such as so called printing liquid, fixing operation processing liquid, or ordinary liquid, for example.

Further, the image forming apparatus includes both a serial type image forming apparatus and a line type image forming apparatus, unless otherwise described herein.

According to v present disclosure, an electric field generated under an image forming device (e.g. a printing head) can be effectively reduced with a simple configuration. That is, an image forming apparatus includes an image forming head that ejects droplets and forms an image on a printing medium; a conveyor that conveys the printing medium with the image in a conveying direction; at least one first electric charger that charges the conveyor; a second electric charger that charges the printing medium; a surface potential detector downstream of the second electric charger in the conveying direction that detects a surface potential of the printing medium; and a controller that adjusts a voltage applied to the second electric charger. The controller determines a target value for the surface potential of the printing medium at a location corresponding to a position of the surface potential detector based on a detection value detected by the surface potential detector in response to a first voltage being applied to the first electric charger and a second voltage being applied to the second electric charger. The controller adjusts the voltage applied to the second electric charger and the surface potential of the printing medium at the location corresponding to the position of the surface potential detector reaches the target value.

According to another aspect of the present disclosure, an electric field generated under an image forming device (e.g. a printing head) can be more effectively reduced according to a type of a printing medium. That is, the controller determines the target value based on the detection value and a value of the second voltage when the detection value is detected.

According to another aspect of the present disclosure, an electric field generated under an image forming device (e.g. a printing head) can be more effectively reduced without computing an electrical resistance value. That is a data table defines a relationship that is stored in the data table between the detection value, a voltage value of the second voltage at a time when a detection value is detected, and the target value. The controller determines the target value based on the voltage value of the second voltage, the detection value, and the relationship defined by the data table.

According to another aspect of the present disclosure, an electric field generated under an image forming device (e.g. a printing head) can be more effectively reduced without influence of an image formed previously on one side of a printing medium. That is the image forming unit forms a first image on a first side of the printing medium, a path switching nail switches the path of printing medium, and the image forming unit forms a second image on a second side of the printing medium. The controller determines a target value for a second side of the printing medium is less than a target value of a first side.

According to another aspect of the present disclosure, an electric field generated under an image forming device (e.g. a printing head) can be more effectively reduced even if a thickness of a printing medium varies. That is a thickness detector detects a thickness of the printing medium, and the target value is determined the detection value and the thickness of the printing medium.

Numerous additional modifications and variations of the present disclosure are possible in light of the above teachings. It is therefore to be understood that within the scope of the appended claims, the present disclosure may be executed otherwise than as specifically described herein. For example, the order of steps for forming in the image forming apparatus is not limited to the above-described various embodiments and may be altered as appropriate.

1. An image forming apparatus, comprising:
an image forming head that ejects droplets and forms an image on a printing medium;
a conveyor that conveys the printing medium with the image in a conveying direction;
at least one first electric charger that charges the conveyor;
a second electric charger that charges the printing medium;
a surface potential detector downstream of the second electric charger in the conveying direction that detects a surface potential of the printing medium; and
a controller that adjusts a voltage applied to the second electric charger,
wherein the controller determines a target value for the surface potential of the printing medium at a location corresponding to a position of the surface potential detector based on a detection value detected by the surface potential detector in response to a first voltage being applied to the first electric charger and a second voltage being applied to the second electric charger,
wherein the controller adjusts the voltage applied to the second electric charger and the surface potential of the printing medium at the location corresponding to the position of the surface potential detector reaches the target value.

2. The image forming apparatus as claimed in claim 1, wherein the controller determines a voltage value of the second voltage at a time the detection value is detected by the surface potential detector, and
wherein the controller determines the target value based on the voltage value of the second voltage and the detection value.

3. The image forming apparatus as claimed in claim 2, wherein the controller includes a memory,
wherein at least one data table is stored in the memory of the controller,
wherein the data table includes a plurality of respective values for each of the detection value, the voltage value of the second voltage, and the target value,
wherein the data table defines a relationship that is stored in the data table between the detection value, the voltage value of the second voltage, and the target value, and
wherein the controller determines the target value based on the voltage value of the second voltage, the detection value, and the relationship defined by the data table.

4. The image forming apparatus as claimed in claim 1, further comprising a path switching nail that switches a path of the printing medium in the image forming unit,
wherein the image forming unit forms a first image on a first side of the printing medium, the path switching nail switches the path of printing medium, and the image forming unit forms a second image on a second side of the printing medium, and
wherein the controller determines a target value for a second side of the printing medium is less than a target value of a first side.

5. The image forming apparatus as claimed in claim 1, further comprising:
a thickness detector to detect a thickness of the printing medium,
wherein the controller determines the target value based on the detection value and a detection result of the thickness detector.

6. The image forming apparatus as claimed in claim 4, further comprising:
a thickness detector to detect a thickness of the printing medium,
wherein the controller determines the target value of at least one of the first side and the second side based on the detection value and a detection result of the thickness detector.

7. A method of controlling surface potential of printing medium in an image forming apparatus comprising:
applying a first voltage to a conveyor of the image forming apparatus;
applying a second voltage to a printing medium;
conveying the printing medium on the conveyor;
detecting a surface potential of the printing medium at a first location along an image forming conveyance path;
determining a target value for the surface potential of the printing medium at the first location based a detection value of the detecting in response to the first voltage being applied and the second voltage being applied; and
adjusting the second voltage applied to the printing medium so the surface potential of the printing medium reaches the target value at the first location.

8. The method of controlling surface potential as claimed in claim 7, further comprising determining a voltage value of the second voltage at a time of the detecting, and
wherein determining the target value includes determining the target value based on the voltage value of the second voltage and the detection value.

9. The method of controlling surface potential as claimed in claim 8, further comprising:
accessing a data table including a plurality of respective values for each of the detection value, the voltage value of the second voltage, and the target value,
wherein the data table defines a relationship between the detection value, the voltage value of the second voltage, and the target value that is stored in the data table, and
wherein determining the target value includes the determining the target value based on the voltage value of the second voltage, the detection value, and the relationship defined by the data table.

10. The method of controlling surface potential as claimed in claim 7, wherein determining the target value includes determining a target value for the surface potential of the printing medium for a first side of the printing medium, and
wherein the method further comprises:
forming an image on a first side of the printing medium,
switching a path of the printing medium on the conveyor, and
determining a target value for the surface potential for the printing medium for a second side of the printing medium is less than the target value for the first side.

11. The method of controlling the surface potential of the printing medium as claimed in claim 7, further comprising detecting a thickness of the printing medium,
wherein determining the target value includes determining the target value based on the detection value and the thickness of the printing medium.

12. The method of controlling the surface potential of the printing medium as claimed in claim 4, further comprising detecting a thickness of the printing medium,
wherein determining the target value includes determining at least one of the target value for the first side and the target value for the second side based on the detection value and the thickness of the printing medium.
